(19) United States
(12) Patent Application Publication
(10) Pub. No.: US 2005/0049026 A1
(43) Pub. Date: Mar. 3, 2005

(54) Method of playing a dice wagering game

(76) Inventor: Mark Angel, Las Vegas, NV (US)

Correspondence Address: ROB PHILLIPS, 5487 VILLA LUCIA COURT, LAS VEGAS, NV, 89141, US

(21) Appl. No.: 10/649,374

(22) Filed: Aug. 28, 2003

(51) Int. Cl. A63F 13/00

(52) U.S. Cl. 463/16

(57) ABSTRACT

A gaming machine having a display device displays a pyramid containing digits one through nine. A player causes the machine to simulate the roll of two dice. Based on the sum of the two dice, the player eliminates one or more of the digits corresponding in value to the sum of the dice. The objective is to eliminate each of the digits such that the pyramid is cleared. The sum of the final roll of the dice must correspond to the sum of the remaining digit(s). Players receive a payout for each cleared pyramid as a function of the final dice roll. A bonus round is reached when a player clears a preestablished number of pyramids. Successive bonus rounds in a set of pyramids may each incorporate a greater potential bonus award. Progressive jackpots corresponding to clearing multiple consecutive bonus pyramids are also contemplated.

### FIELD OF THE INVENTION

The embodiments of the present invention relate to an electronically implemented method of playing a wagering game. More particularly, a wagering game utilizing dice and involving player interaction.

### BACKGROUND

While gaming continues to be legalized in new jurisdictions, gaming establishments strive for new and unique wagering games to attract and retain gamblers. Recently gaming machines have surpassed table games in both popularity and ability to generate profits. For example, in the United States, slot machines and video poker machines now account for a majority of casino profits. Thus, casinos and related gaming establishments seek wagering games which are facilitated by gaming machines.

It is also important that new wagering games use common gaming indicia and are simple to play and fast-paced. Video poker is the prime example of an interactive gaming machine which incorporates the attributes needed to create a popular gaming machine. In its simplest form, video poker begins by displaying five playing cards from a standard deck of playing cards. Thereafter, a player selects which of the cards to hold and which cards to discard. The discards are replaced with remaining cards from the deck. A pay table sets forth payouts corresponding to preestablished poker hand rankings. For example, should the player receive four Aces, the player may be awarded 200 times an original wager.

Video poker is popular because it is simple and fast-paced. In addition, gamblers are familiar with playing cards and understand their premise. Another gaming indicia that provokes familiarity and understanding are standard six-sided dice. Other than craps, no dice games have become very popular in the casinos.

There is a need for a wagering dice game that can be implemented on an electronic gaming machine. In order to achieve popularity, the embodiments of the wagering game disclosed herein are simple, fast-paced and involve player interaction.

### SUMMARY

The embodiments of the present invention provide a wagering game for addressing the continued need for new and unique wagering games capable of electronic implementation. Moreover, the embodiments utilize one or more standard six-sided dice.

In a first embodiment, a gaming machine display depicts a pyramid containing arranged single digits one through nine. A player begins play by placing a wager in the form of coins, bills or credit style card. The player then causes the gaming machine to simulate the roll of two standard six-sided dice. Based on the sum of the roll, the player may eliminate one or more of the single digits corresponding in value to the sum of the rolled dice. The overall objective is to eliminate each of the digits one through nine in an exact fashion. For example, should the player roll a total of six, the player may eliminate any combination of digits that total six including the digits one, two and three, the two and four, the one and five or the six. A player wins a round of the game by eliminating each of the digits such that the final roll of the dice equals the total sum of the remaining digits. In other words, the player must eliminate at least one digit per roll. Should the total number of digits remaining be six or less, the player may opt to roll one die a single time. Should the player successfully eliminate the pyramid digits, the player is awarded a payout based on the sum of the final digit or digits eliminated. In other words, the more difficult it is to eliminate the total sum of the remaining digits the greater the payout. For example, achieving a final total of ten would correspond to a greater payout than rolling a final total of six since the ten is more difficult to roll than the six.

To create continued excitement, a potential bonus corresponds to a number of pyramids that are cleared. A storage means in communication with a gaming machine processor tracks the number of pyramids cleared by a player during a playing session. Once the player clears a predetermined number of pyramids (e.g. nine), the player is thrust into a bonus round. The bonus round consists of a player attempting to clear a bonus pyramid identical to the pyramids of the primary wagering game. Should the player clear the bonus pyramid the player is paid a bonus payout. In a first embodiment, the bonus payout is related to the number of the bonus pyramid cleared. In other words, if the player clears nine pyramids and the bonus pyramid the player may be paid a first payout. Should the player go on during the same playing session to clear another nine pyramids and play a second bonus pyramid the bonus payout will be greater than the first bonus payout and so on. The increase in the bonus payout may or may not be dependent on the results of the previously played bonus pyramids.

A progressive jackpot is associated with a player consecutively clearing a preestablished number of bonus pyramids (e.g. nine) during a playing session. As with the primary wagering game pyramids, the storage means tracks to the number of consecutively cleared bonus pyramids. Should the player fail to clear any bonus pyramid during the playing session, the game does not reset but continues through each successive bonus pyramid thereby eliminating the player's chance to win the progressive jackpot during that playing session.

An internal timer causes the storage means to reset should the gaming machine not be played for a predetermined length of time (e.g. 5 minutes). In this manner, a new player is not afforded the benefits of a previous player's play session. Thus, should a first player need to clear one more pyramid to reach a bonus round when the first player stops playing, the internal timer will reset the gaming machine so that a second player will have to clear the predetermined number of pyramids prior to entering a bonus round.

These and various other features which characterize the invention are pointed out with particularity in the claims annexed hereto and which form a part hereof. However, for a better understanding of the invention, its advantages, and the objects obtained by its use, reference should be made to the drawings which form a further part hereof, and to the accompanying descriptive matter, in which there is illustrated and described preferred embodiments of the invention.

### BRIEF DESCRIPTION OF THE DRAWINGS

FIG. 1 illustrates a gaming machine panel of the type that may be used to implement an electronic version of the embodiments of the present invention;

FIG. 2 illustrates a pyramid containing single digits one through nine;

FIG. 3 illustrates a flow chart illustrating the steps in playing a wagering game according to a first embodiment of the present invention; and

FIG. 4 illustrates a possible pay table associated with the embodiments of the present invention.

### DETAILED DESCRIPTION

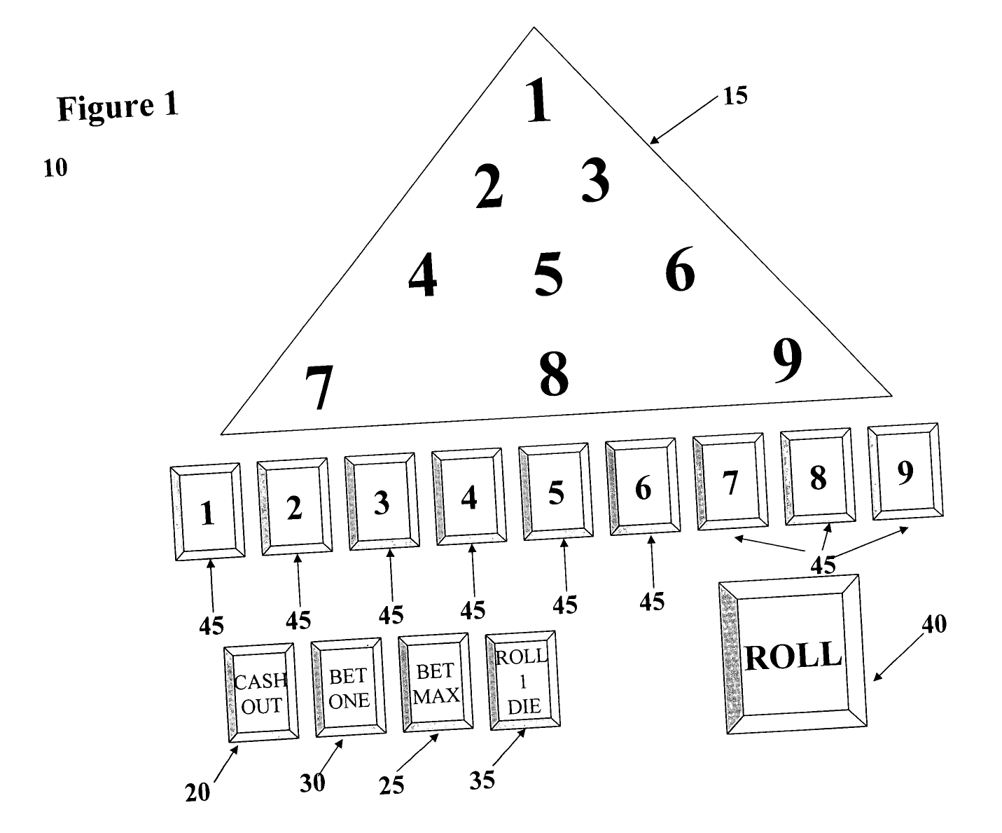

Reference is now made to the figures wherein like parts are referred to by like numerals throughout. FIG. 1 illustrates a gaming machine panel 10, including a screen display 15, cash out button 20, bet maximum coins button 25, bet one coin button 30, one dice button 35 and roll button 40. In addition to the external features illustrated in FIG. 1, the present invention includes a touchscreen that provides a player with means to select certain displayed features as explained below. Although a touchscreen is the preferred means of selection, other means, including selection buttons 45 may be used. It is noted that the gaming machine panel 10 is only part of the gaming machine. The gaming machine will further include external features of a card reader, currency slot, coin slot, voucher slot and internal components including a gaming machine processor and storage device. The internal operations and components of electronic gaming machines are well known to those skilled in the art and are not described herein for the sake of brevity.

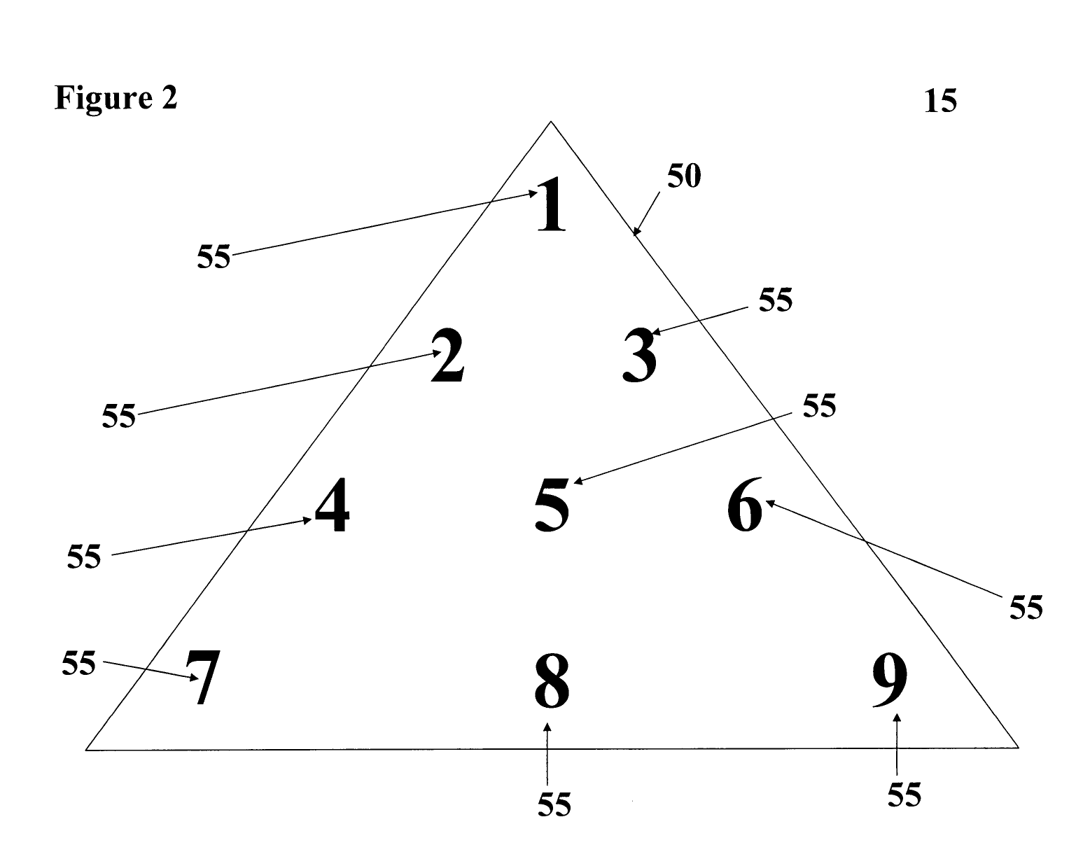

Referring now to FIG. 2, a pyramid generally denoted as reference number 50 is illustrated containing single digits 55-1 through 55-9. In practice the pyramid 50 and digits 55-1 through 55-9 are displayed on the gaming machine display 15. While pyramids are illustrated, the digits 55-1 through 55-9 may be displayed in any format desired. In addition, the range of digits may be reduced or expanded beyond the digits one through nine.

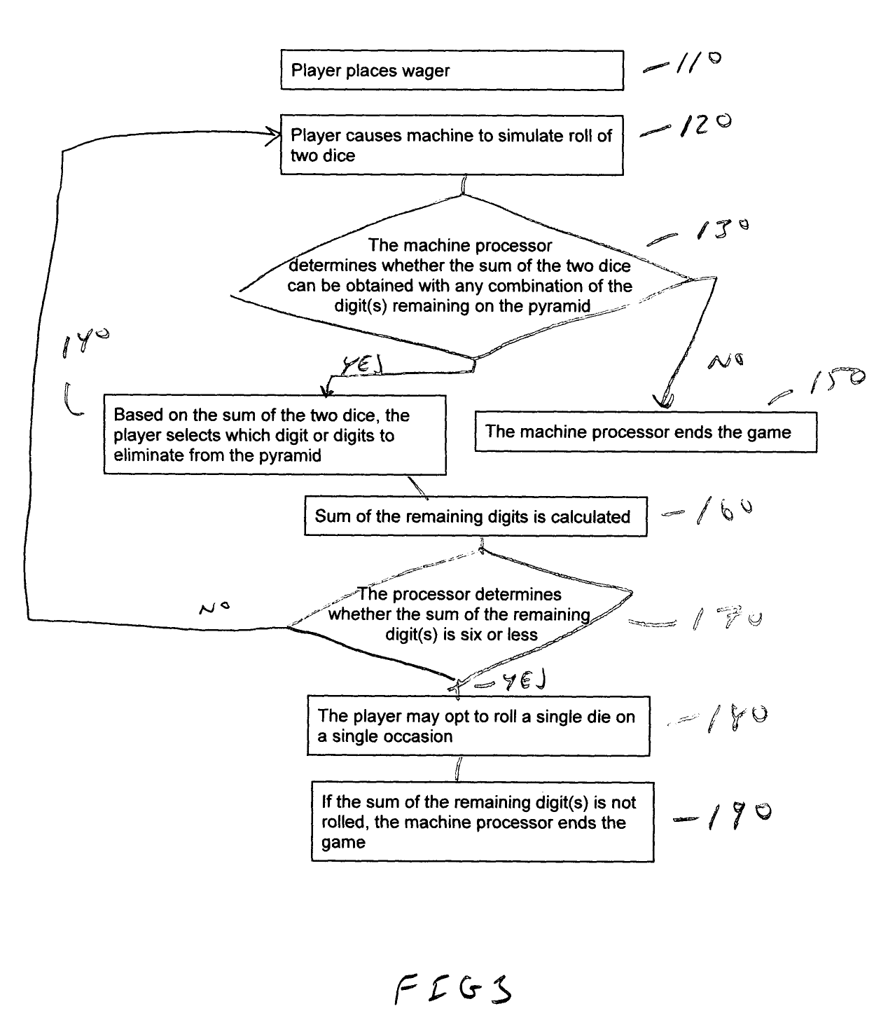

FIG. 3 illustrates a flow chart detailing a method of playing the embodiments of the present invention. At step 110, a player places a wager. The gaming machine can accept wagers in the form of coins, bills, credit style cards or credit vouchers. The amount of wagers is determined by a gaming establishment offering the embodiments of the present invention. Once the wager is placed, at step 120 the player causes the gaming machine to simulate a roll of two six-sided dice. At step 130, the machine processor determines whether the sum of the two dice can be obtained by a single digit or any combination of the digits remaining on the pyramid 50. If so, at step 140, based on the sum of the two dice, the player selects which digit or digits 55-1 through 55-9 to eliminate from the pyramid 50. The selection can be made by means of touchscreen technology or selection buttons 45. If not, at step 150 the machine processor ends the game. At step 160, the sum of the remaining digits is calculated. At step 170, the processor determines whether the sum of the remaining digits is six or less. If so, at step 180, the player may opt to roll a single die on a single occasion. For example, if digits two 55-2 and three 55-3 remain, the player may use one die and attempt to roll a five. A pay table sets forth a payout associated with rolling one die. At step 180, if the sum of the remaining digits is not rolled, the machine processor ends the game at step 190. If at step 170 the sum of the remaining digits is determined to be more than six, the chart loops back to step 120 and the player causes the gaming machine to simulate the roll of the two dice again and the steps are repeated until all digits are eliminated or the processor ends the game.

The selection buttons 45 represent the numbers 1 through 9. At the start of a game, the selection buttons 45 and digits 55-1 through 55-9 are each illuminated. Once a player depresses a particular selection button 45, the illumination of the button 45 and the corresponding digit 55-1 through 55-9 is turned off thereby indicating that the number is no longer available. The implementation of touchscreen technology eliminates the selection buttons 45 but the digits 55-1 through 55-9 continue to be illuminated prior to selection.

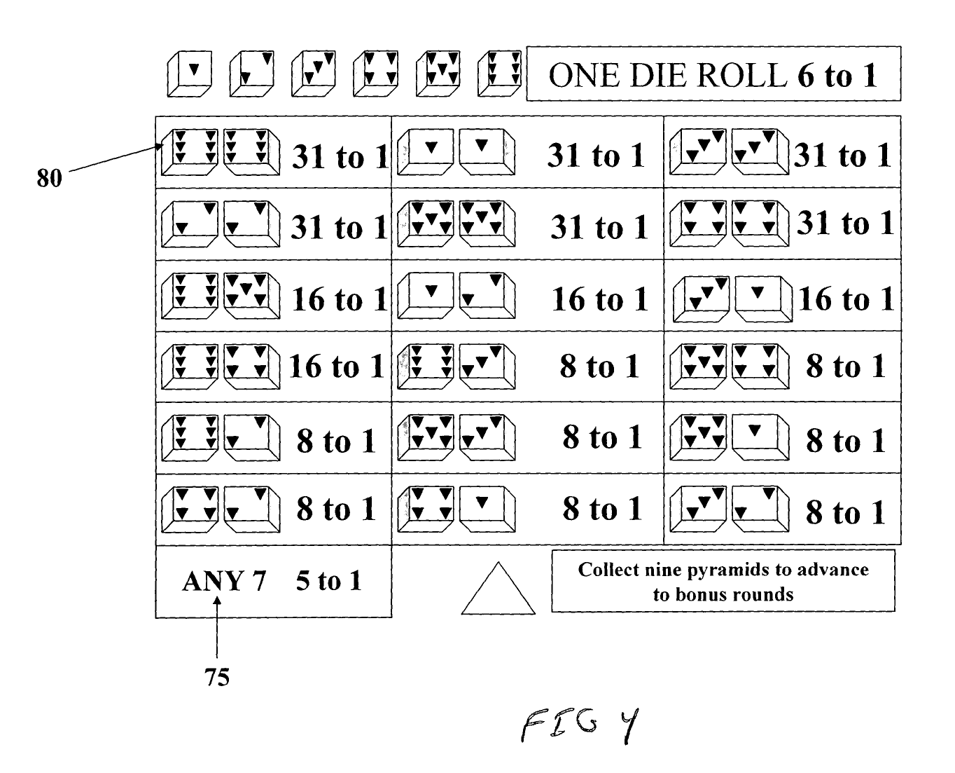

If all digits are eliminated, the machine processor automatically ends the game and the player is deemed a winner. While any payout structure may be implemented, a first embodiment causes a player to receive a payout associated with the value of the final digit or digits eliminated. FIG. 4 illustrates a pay table having payouts related to the final roll of the dice. Generally, the payouts are determined by the difficulty of the final roll of the dice. In other words, any seven 75 pays 5 to 1 while a twelve 80 pays 31 to 1 since it is much more likely that a seven will occur than a twelve. Thus, players can form a strategy of play in an effort to maximize the potential payouts.

Example of Winning Play

| Sum of First Roll | Digit(s) Eliminated | Digit(s) Remaining |
|---|---|---|
| 8 | 5,3 | 1,2,4,6,7,8,9 |
| 9 | 7,2 | 1,4,6,8,9 |
| 10 | 6,4 | 1,8,9 |
| 9 | 1,8 | 9 |
| 9 | 9 | None |

Since the final roll was a nine, the payout will correspond to the multiple possibilities of rolling a nine (e.g. 3,6, or 4,5). In this case, the payout is the same at 8 to 1. Of course, the player may elect to eliminate different digits than those depicted by the winning play above. For example, the player could eliminate only the eight, rather than the 5,3, in reference to the initial roll of an 8.

Example of Losing Play

| Sum of First Roll | Digit(s) Eliminated | Digit(s) Remaining |
|---|---|---|
| 8 | 5,3 | 1,2,4,6,7,8,9 |
| 9 | 7,2 | 1,4,6,8,9 |
| 10 | 6,4 | 1,8,9 |
| 9 | 1,8 | 9 |
| 6 | None | 9 |

Since no digit or digits could be eliminated with the roll of a six, the games ends. Each roll must involve at least the elimination of one digit.

A bonus round is related to a preestablished number of pyramids being cleared. For example, should the preestablished number be nine pyramids, the player is thrust into a bonus round once the player clears nine pyramids. Thereafter, in the bonus round, the player plays the same game but receives enhanced payouts. In a first embodiment, the enhanced payout is achieved if the bonus pyramid is cleared. As with the primary game, the bonus payout is related to the final value of the digit or digits eliminated.

A progressive jackpot is also contemplated with the embodiments of the present invention. A progressive jackpot may be related to the single gaming machine, a bank of gaming machines or a networked system of gaming machines over multiple properties. In a first embodiment, the progressive jackpot requires the player to play the maximum number of coins for each play. It is well known in the gaming industry that gaming machines conventionally include multiple pay tables related to the number of coins played. In the first embodiment, to win the progressive jackpot, a player must consecutively clear each bonus pyramid in a set of pyramids. For example, in a multiple property embodiment, the set of pyramids may comprise nine pyramids, each requiring the player to clear nine pyramids to reach the bonus round. Thus, the player would have to reach the bonus level for each of the nine pyramids in the set and clear each bonus pyramid as well. Should the player fail to clear any bonus pyramid in the set, the progressive jackpot cannot be won by the player within that pyramid set. In another example, should the progressive jackpot be based on a bank of machines, the player may only have to clear six sets of pyramids and six corresponding bonus pyramids to win the bank progressive jackpot. Accordingly, should the progressive jackpot be based on a single machine, the player may only have to clear three sets of pyramids and three corresponding bonus pyramids to win the machine progressive jackpot.

The gaming machine storage device, such as computer memory, in communication with a gaming machine processor retains the number of pyramids cleared by the player during a player session and the number of consecutively cleared bonus pyramids. Additionally, a visible indicator 60 on the display 15 keeps the player informed as to the number of pyramids cleared thereby keeping the player informed as to the number of pyramids which need to be cleared to reach the bonus round. The indicator 60 may be in any conceivable form. For example, a series of illuminated pyramids on the display may represent each pyramid cleared or a single pyramid may have the number of cleared pyramids depicted therein.

An internal timer of the gaming machine in communication with the machine processor tracks the idle time of the gaming machine. Should the idle time reach a preestablished maximum (e.g. 5 minutes), the gaming machine resets the number of pyramids cleared by the player. For example, should a player leave the gaming machine for a length of time greater than the preestablished maximum time interval, the processor instructs the storage device to reset the number of cleared pyramids to zero. Therefore, a first player's cleared pyramids cannot be used for the benefit of a second player if the idle time should reach the preestablished maximum.

It is to be understood, however, that even though numerous characteristics of the present invention have been set forth in the foregoing description, together with an explanation of various possible embodiments and modifications thereto, this disclosure is illustrative only and changes may be made within the spirit of the invention to the full extent indicated by the broad general meaning of the terms in which the appended claims are expressed.

1. A electronically implemented method of playing a dice wagering game comprising the steps of:
a. accepting a player wager;
b. displaying a series of numbers on a gaming machine display;
c. providing a simulated roll of two six-sided dice;
d. providing selection means for a player to eliminate from play one or more of the numbers corresponding in sum to a sum of the two rolled dice; and
e. providing means for repeating steps c. and d. until the sum of the two dice equals the sum of the one or more numbers not eliminated from play thereby resulting in a win for the player or the sum of the dice cannot be equaled by the sum of the one or more numbers not eliminated from play in step d. thereby resulting in a loss for the player.

2. The method of claim 1 wherein a player is awarded a payout according to a preestablished pay table for winning a play by clearing the series of numbers.

3. The method of claim 2 wherein the payout is related to the final roll of the dice.

4. The method of claim 1 wherein the player may elect to roll one die a single time if the a sum of the numbers not eliminated is six or less.

5. The method of claim 1 wherein the displayed series of numbers are arranged in a shape of a pyramid.

6. The method of claim 1 wherein the series of numbers are one through nine.

7. The method of claim 1 wherein a bonus round is activated once the player clears a preestablished number of pyramids.

8. The method of claim 1 wherein a progressive jackpot is related to a number of consecutively cleared bonus pyramids.

9. A gaming machine comprising:
a machine processor;
a display for displaying a series of numbers;
means for accepting a player wager;
selection means for a player to eliminate from play one or more of the displayed numbers corresponding in value to a sum of two processor simulated rolled dice; and
means for repeating the simulated dice roll and the selection means until the sum of the two dice equals the sum of the one or more numbers not eliminated from play thereby resulting in a win for the player or the sum of the dice cannot be matched by the sum of the one or more numbers not eliminated from play thereby resulting in a loss for the player.

10. The machine of claim 9 wherein the displayed series of numbers are one through nine.

11. The machine of claim 9 wherein the machine processor provides a player with an option to roll a single dice one time if the sum of the one or more numbers not eliminated is six or less.

12. The machine of claim 9 wherein the machine processor activates a bonus round once the player clears a preestablished number of pyramids.

13. The machine of claim 9 wherein a storage device in communication with the machine processor causes the display of an indicator signifying the number of pyramids previously cleared.

14. The machine of claim 13 wherein an internal timer causes the storage device to reset the number of pyramids previously cleared to zero in response to the machine being idle for a preestablished time interval.

15. The machine of claim 9 wherein the selection means for the player to eliminate one or more of the displayed numbers is a touchscreen display.

16. A gaming machine comprising:
a machine processor;
a touchscreen display for displaying a series of numbers;
means for accepting a player wager;
the touchscreen display providing the player means to eliminate from play one or more of the displayed numbers corresponding in value to a sum of two processor simulated rolled dice; and
the processor providing means for the player to repeat the simulated dice roll and the touchscreen display providing means for the elimination of one or more of the numbers until the sum of the two dice equals the sum of the one or more numbers not eliminated from play thereby resulting in a win for the player or the sum of the dice cannot be matched by the sum of the one or more numbers not eliminated from play thereby resulting in a loss for the player.

17. The machine of claim 16 wherein the displayed series of numbers are one through nine.

18. The machine of claim 16 wherein the machine processor provides a player with an option to roll a single dice one time if the sum of the one or more numbers not eliminated is six or less.

19. The machine of claim 16 wherein the machine processor activates a bonus round once the player clears a preestablished number of pyramids.

20. The machine of claim 16 wherein a storage device in communication with the machine processor causes the display of an indicator signifying the number of pyramids previously cleared.

21. The machine of claim 20 wherein an internal timer causes the storage device to reset the number of pyramids previously cleared to zero in response to the machine being idle for a preestablished time interval.

22. The machine of claim 16 wherein the selection means for the player to eliminate one or more of the displayed numbers is a touchscreen display.
